(19) United States
(12) Patent Application Publication
(10) Pub. No.: US 2018/0355989 A1
(43) Pub. Date: Dec. 13, 2018

(54) DEVICE FOR PROTECTING A SPRINKLER HEAD

(71) Applicant: Tres Bedell, Glen Allen, VA (US)

(72) Inventor: Tres Bedell, Glen Allen, VA (US)

(21) Appl. No.: 15/631,838

(22) Filed: Jun. 23, 2017

Related U.S. Application Data
(60) Provisional application No. 62/516,473, filed on Jun. 7, 2017.

(51) Int. Cl. F16K 27/12; A62C 37/08

(52) U.S. Cl. CPC F16K 27/12; A62C 37/08; B32B 2571/00; B32B 2439/46; B32B 2439/06

(57) ABSTRACT

Described is a device for insulating a fire-sprinkler-head assembly from excessive heat. The cover includes a tubular body having a closed end and an open end. The tubular body is made of a flexible insulating material, and has a bore therethrough large enough to encase a fire-sprinkler-head assembly therein. The tubular body includes a tapering portion that narrows toward the open end. An expandable-vertical slit is disposed along the tapering portion. The expandable-vertical slit includes a first edge, and a second edge forming two sides the opening. A flap is positioned along the first edge of the vertical slit. The flap is configured to hingedly wrap around and adjustably cover the expandable-vertical slit. A collar is coextensive with a boundary of the exterior portion of the open end. The collar is configured to expand to receive a fire-sprinkler-head assembly therein when the cover is placed over the fire-sprinkler-head assembly.

### CROSS REFERENCE TO RELATED APPLICATIONS

This application claims the benefit of U.S. Provisional Patent Application No. 62/516,473, filed on 7 Jun. 2017, entitled “Device for Protecting a Sprinkler Head,” the entirety of which is hereby incorporated by reference.

### BACKGROUND OF THE INVENTION

### (1) Technical Field

This specification relates to thermal protection of sprinkler heads, and more specifically, to a device configured to cover and prevent a sprinkler-head assembly from exceeding a maximum threshold temperature when the room in which the assembly is located is exposed to heat generated from a heat source used to exterminate bed bugs.

### (2) Background Art

Bed bugs are parasitic insects that feed on human or pets. Bed bugs are most active at night when their host is typically sleeping.

Unfortunately, present-day pesticides are generally ineffective at killing bed bugs. Consequently, bed bugs are increasingly infesting hotels—regardless of how swanky the hotel—hospitals, nursing homes, college dormitories, office buildings, and apartment buildings. In other words, bed bugs are increasingly prevalent anywhere where humans travel or sleep.

Without effective pesticides, most professional exterminators use thermal heating to kill bed bugs. Thermal heating involves exposing an infested room to a heat source for a continuous period of time. The heat permeates most spaces in a room including crevices that bed bugs like to hide. Ideally, the heat source will raise the temperature of the room to about 140° F. for a minimum duration needed to kill the bed bugs, their eggs, and larva.

However, the process of heating a room in a building is often inexact. For instance, in large scale extermination efforts the room may be exposed to temperatures that fluctuate, or hot spots occur that may exceed 140° F. If the room temperature exceeds 140° F., and there are sprinkler heads in the room, this excessive heat may trigger an undesirable activation of the sprinkler system.

Upon activation, each activated sprinkler head will unleash a torrent of water—on average 20 to 40 gallons of water per minute flows from each sprinkler—which will cause water damage to the room, and perhaps floors underneath the treated room in a matter of seconds. Furthermore, replacing a broken sprinkler head after a false-triggering event is extremely expensive, and time consuming.

Therefore, to avoid accidently triggering sprinklers in an infested area, an exterminator will typically try to cover each sprinkler head in proximity to the heat source. In many instances, ice or dry ice is packed inside the cover to help keep the sprinkler-head assembly cool during the heating process. After the heating process is completed, the cover is detached from the sprinkler head.

However, a sprinkler-head assembly contains fragile glass or other delicate parts. Unfortunately, some covers used to protect the sprinkler-head assembly may actually damage the sprinkler-head assembly when being attached or detached to the assembly.

For instance, some current state-of-the-art covers are screwed directly into the sprinkler-head assembly itself. Screwing a cover loaded with ice into the sprinkler-head assembly itself may damage the sprinkler-head assembly, or its parts. Conversely, after the heat treatment is completed, each cover must be carefully removed from the assembly. The reverse process of removing protective covers from each assembly head is also time consuming, and must be performed gingerly to avoid damaging the assembly. Therefore, the total process is man-hour intensive, and may inadvertently damage the assembly.

Other cover systems use magnets to attach the cover to the sprinkler head. These covers must align exactly with circular metal on the outside of the sprinkler head. Often times the circumferences of the sprinkler head and the magnetic cover are not aligned with each other, making it impossible for the cover to securely mate with the sprinkler-head assembly. Moreover, these covers can unexpectedly fall off the sprinkler head if water or ice packed in the cover is too heavy for the magnet.

In addition, many sprinkler heads are located in exposed ceilings (i.e., unfished ceilings). Covers that use magnets cannot attach to exposed sprinkler heads that have no supporting wall or ceiling structure. Or the cover may not fully envelope the sprinkler assembly on all sides, and therefore cannot adequately shield the assembly from excessive heat.

Some covers require extension poles, instead of magnets, to maintain the cover over the assembly. The extension poles must be adjusted to extend from the ground to the ceiling to hold the cover over the assembly. Therefore, each pole must remain in place, during the entire heating process. Each pole is often unsteady, and can easily be knocked over during the heating process. Many poles cannot be adjusted to fit ceiling heights that are greater than seven or eight feet. Further, the extension-pole system does not work well with sprinklers located in exposed ceilings (unfinished ceilings), with just a bare pipe and with no supporting wall or ceiling structure.

Further, sprinkler heads come in a variety of different sizes, and configurations. Therefore, current covers may not fit different sized sprinkler assemblies. Still further, some sprinkler heads are configured in tight spots making it difficult if not impossible to position the cover (such as metal caps, and Styrofoam covers) over the sprinkler head assembly. And as mentioned above, many sprinkler heads have no supporting structure for which to attach the cover.

Thus, current cover systems used to protect sprinkler-head assemblies during heat treatments are deficient for at least the aforementioned reasons.

### SUMMARY

Described is a device for preventing a fire-sprinkler-head assembly from being activated during a controlled-heating event, and addresses many of the deficiencies discussed above. The device is configured to cover, insulate, and thereby keep the sprinkler-head assembly at an acceptable temperature when exposed to a heat source for exterminating bed bugs. The device also has quick attachment and detachment mechanisms.

In one embodiment, the device includes a tubular body having a closed end and an open end. The tubular body is made of a soft flexible insulating material, and has a bore therethrough large enough to encase a fire-sprinkler-head assembly therein. The tubular body includes a tapering portion that narrows toward the open end. An expandable-vertical slit is disposed along the tapering portion. The expandable-vertical slit includes a first edge, and a second edge forming two sides the opening. A flap is positioned along the first edge of the vertical slit. The flap is configured to hingedly wrap around and adjustably cover the expandable-vertical slit. A collar is coextensive with a boundary of the exterior portion of the open end. The collar is configured to expand to receive a fire-sprinkler-head assembly therein when the device is placed over the fire-sprinkler-head assembly. The collar may also have a securing/release mechanism.

In one aspect, the device is made of a soft, and flexible neoprene material of a suitable thickness that when the cover is placed over a sprinkler-head assembly, and secured thereto, the cover thermally insulates the sprinkler head from temperatures that may exceed a threshold, which causes the sprinkler head mechanism to activate water.

Because the device is composed of a flexible material ice may be packed inside the device's bore to ensure the air temperature inside the device remains well below the threshold-heat level to activate the sprinkler head.

In another aspect, the collar of the device is universal, configured to fit over and securely attach to almost any sized or configured sprinkler-assembly head, without impairing the integrity of sprinkler assembly. The device can attach or detach from a sprinkler head in a matter of seconds, and does not directly attach to the sprinkler-head mechanisms themselves.

In another aspect, the combination of the flexible-insulating material of the device, and its adjustable collar, vertical slit, and flap, allow the device to be adjustably tightened to fit securely around almost any configured fire-sprinkler head assembly.

This summary is provided to introduce a selection of concepts in a simplified form that are further described below. This summary is not necessarily intended to identify key features or essential features of the claimed subject matter, nor is it necessarily intended to be used as an aid in determining the scope of the claimed subject matter.

The foregoing outlines examples of this disclosure so that those skilled in the relevant art may better understand the detailed description that follows. Additional embodiments and details will be described hereinafter. Those skilled in the relevant art should appreciate that they can readily use any of these disclosed embodiments as a basis for designing or modifying other structures or functions for carrying out the invention, without departing from the spirit and scope of the invention.

Reference herein to “one embodiment,” “an embodiment,” “an aspect,” “an implementation,” “an example,” or similar formulations, means that a particular feature, structure, operation, or characteristic described in connection with the embodiment is included in at least one embodiment of the present invention. Thus, different appearances of such phrases or formulations herein do not necessarily refer to the same embodiment. Furthermore, various particular features, structures, operations, or characteristics may be combined in any suitable manner in one or more embodiments.

### BRIEF DESCRIPTION OF THE DRAWINGS

The detailed description is described with reference to the accompanying figures. In the figures, the left-most digit(s) of a reference number identifies the figure in which the reference number first appears. The figures are not necessarily drawn to scale.

FIG. 1 is a perspective view of a device for protecting a fire-sprinkler-head assembly (see FIG. 6) from excessive heat or cold.

FIG. 2 shows a vertical longitudinal sectional view taken along the line 2-2 of FIG. 1, showing the general contour and thickness of an example device's body for covering a sprinkler head.

FIG. 3 shows a perspective view of the example device for protecting a fire-sprinkler-head assembly, in which the flap is fastened around the opening of the slit.

FIG. 4 shows a top view of a collar of the example device taken on line 4-4 of FIG. 1 looking into tubular body from the open end. As appreciated, the term “top view” is used purely as drawing term, and does not necessarily mean the top of the example device.

FIG. 5 shows a bottom view of tubular body of FIG. 1, i.e., viewed looking down at the closed end of the device. As appreciated, the term “bottom view” is used purely as drawing term, and does not necessarily mean the bottom of the example device.

FIG. 6 shows a transparent view of the innovative device with a fire-sprinkler-head assembly partially contained within the bore of the device.

### DETAILED DESCRIPTION

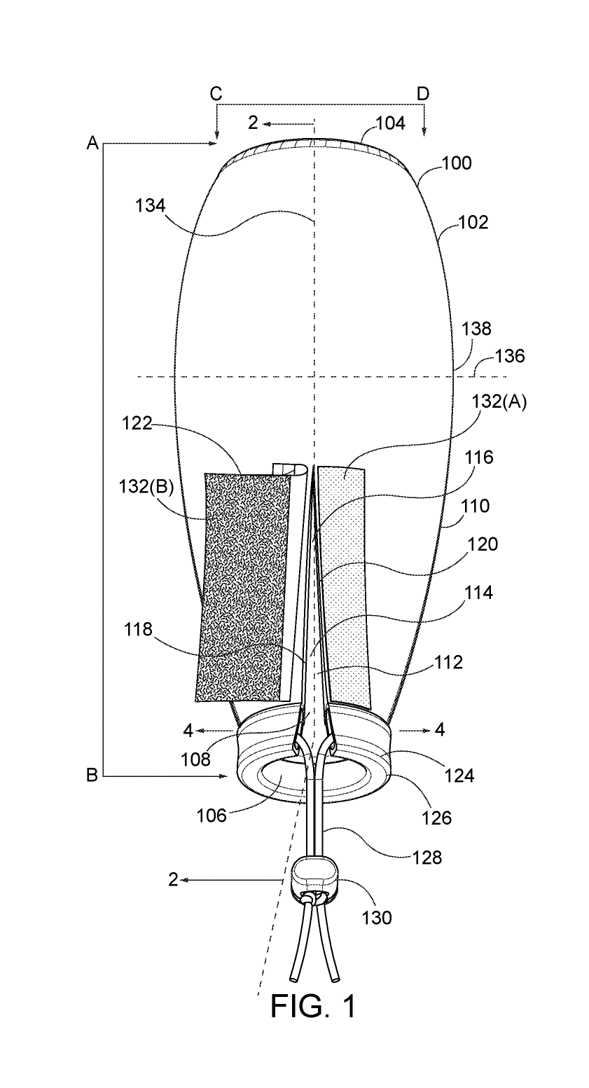

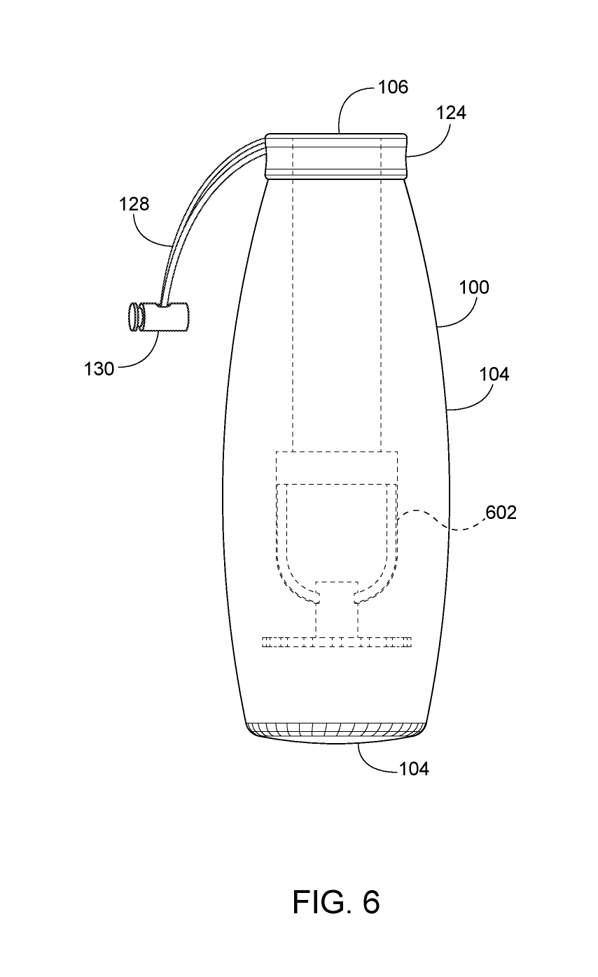

FIG. 1 is a perspective view of a device 100 for protecting a fire-sprinkler-head assembly (see 602 of FIG. 6) from excessive heat or cold.

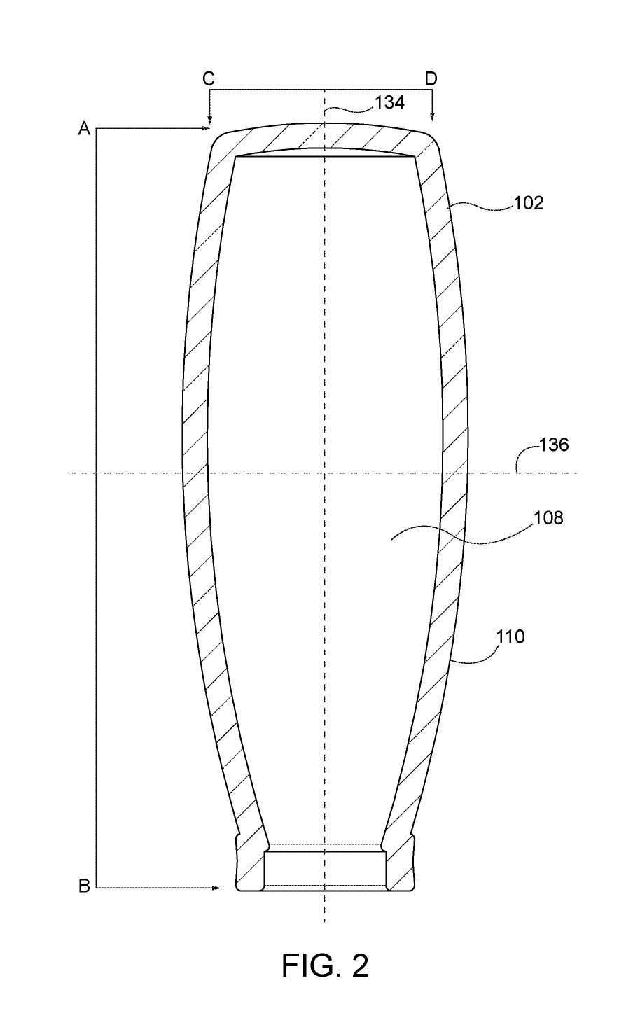

Referring to FIG. 1, in one embodiment, device 100 includes: a tubular body 102, a closed end 104, an open end 106, a bore 108 (see also FIG. 2), a tapering portion 110, an expandable-vertical slit 112, a triangular opening 114, a vertex 116, a first edge 118, a second edge 120, a flap 122, a collar 124, a casing 126, a drawstring 128, a cordlock 130, hook and loop strips (i.e. Velcro strips) 132(A), 132(B). Tubular body 102 also has a vertical axis 134, and a horizontal axis 136.

In the illustrated embodiment, device has an external configuration in the shape of tubular body 102, which appears in this example in the general shape of a bottle, and therefore, is generally cylindrical in shape. However, as appreciated by those skilled in the art, after having the benefit of this disclosure, tubular body 102 may be of other external configurations, and shapes, such as rectangular, hexagonal or other suitable three-dimensional configurations large enough to accommodate a sprinkler-head assembly 602 (FIG. 6) therein.

As depicted in the illustrated embodiment of FIG. 1, tubular body 102 is constructed of a flexible-insulating material that is stable and maintains its flexibility properties over a wide temperature range. In addition, the insulating material is resistant to cold and heat.

For example, in one aspect tubular body 102 is constructed primarily of neoprene. Additionally, other materials may be used with the neoprene, such as an inner liner (not shown), or outer skin (not shown) made of aluminum foil, or other flexible materials that are heat resistant and potentially water resistant.

As shown in FIG. 1, tubular body 102 has a closed end 104 and an open end 106, and a bore 108 (i.e. a borehole) therethrough (see FIG. 2, which shows a vertical-longitudinal-sectional view taken along the line 2-2).

Referring to FIGS. 1 and 2, in one embodiment, bore 108 is generally cylindrical and generally contoured to fit around and encase a fire-sprinkler head assembly 602 (FIG. 6) therein. Referring to FIG. 2, tubular body 102 has a suitable thickness to generally insulate its bore 108 and maintain a temperature, which is generally well below the threshold for triggering a sprinkler system even though the environmental temperature outside body 102 may exceed the maximum threshold temperature to activate the sprinkler. In one embodiment, a single layer of neoprene is used as the insulating material for body 102, that has thickness of about between about 4 mm and 6 mm thick measured between an inner surface of body 102, and an outer-external surface of body 102.

Referring back to FIG. 1, bore 108 has a length and width—measured along vertical axis 134, and horizontal axis 136, respectively—slightly greater than most standard fire-sprinkler-head assemblies. This extra space provides room to accommodate ice inside bore 108, while also covering the fire-sprinkler-head assembly.

For instance, in one example, the length of tubular body 102 measured between points A and point B is about eight inches, and the width of the non-tapering portion of tubular body 102, measured between points C and D (when the tubular body is flat) is about four inches. However, as appreciated by those skilled in the art, after having the benefit of this disclosure, tubular body 102 may be longer or shorter than eight inches, or may be wider or narrower than four inches.

Tubular body 102 includes a tapering portion 110 that narrows (i.e., tapers downwardly from a non-tapering portion (i.e., aft portion) 138 of toward open end 106. In one embodiment, at its narrowest point, tapering portion 110 is about two inches wide. And in one embodiment, at its widest point, around non-tapering portion 138, tapering portion is about four inches wide. Tapering portion 110 is about four inches in length measured along vertical axis 134 between point 138 and 4-4. However, as appreciated by those skilled in the art, after having the benefit of this disclosure, the dimensions of tapering portion 110 may be longer, shorter, wider and/or narrower than the aforementioned dimensions.

In one embodiment, there is an expandable-vertical slit 112, disposed along tapering portion 110. Expandable-vertical slit 112 is a void (i.e., a cutaway) through the sheet of material comprising tubular body 102. In the illustrated example of FIG. 1, expandable-vertical slit 112 forms a triangular opening 114 that extends along tapering portion 110 in parallel with vertical axis 134 of tubular body 102. Expandable-vertical slit 112 widens toward open end 106 of tubular body 102, and narrows to a vertex 116 closest to closed end 104. Expandable-vertical slit 112 includes a first edge 118, and a second edge 120—both edges forming two sides of triangular opening 114.

In one embodiment, when expandable-vertical slit 112 is in a relaxed position, and is not stretched, vertex 116 is generally an acute angle. For example, in the illustrated embodiment of FIG. 1, vertex 116 has an angle of about 25 degrees. However, as appreciated by those skilled in the art, after having the benefit of this disclosure, the exact angle of vertex 116 may vary from about 10 degrees to over 90 degrees. In addition, the angle of the vertex 116 may expand when tubular body 102 is slid over a fire-sprinkler-head assembly, if the assembly is larger than the external circumference of open end 106.

Also as appreciated by those skilled in the art, after having the benefit of this disclosure, expandable-vertical slit 112 may have non-triangular configurations, such as arc shaped, rectangular, or other configurations. Further, although a single slit 112 is shown, there may be multiple slits located in body 102, and more specifically in tapering portion 110.

Flap 122 is positioned along first edge 118 of the vertical slit 112. Flap 122 may be hingedly attached to tubular body 102. Flap's 112 edge (not visible in FIG. 1) is positioned immediately adjacent to and aligns with first edge 118. Flap 122 may be composed of a flexible and stretchable insulating material.

In one example, flap 112 is composed of a stretchable neoprene. Flap 112 may have a thickness of about between 1 mm and 6 mm. However, as appreciated by those skilled in the art, after having the benefit of this disclosure, other materials may be used in lieu of neoprene for flap 112, such as canvas, rubber, nylon, leather, or other suitable materials. In addition, the thickness of flap 112 may vary.

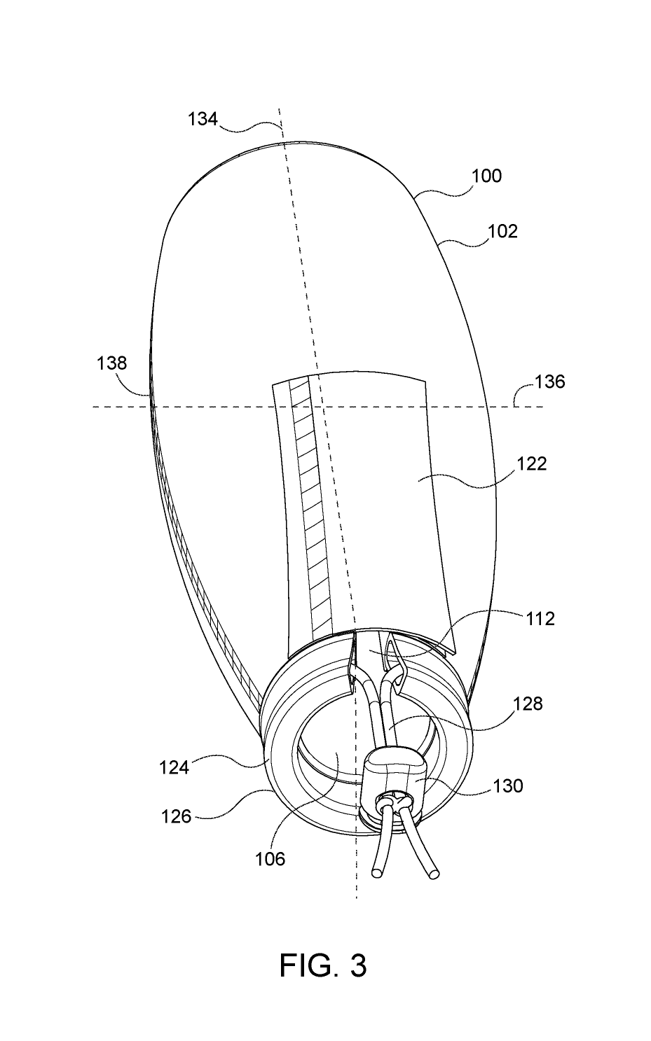

Flap 122 is configured to hingedly wrap around and adjustably cover the expandable-vertical slit 112. For example, FIG. 3 shows a perspective view of a device 100 for protecting a fire-sprinkler-head assembly, in which flap 112 is fastened around slit 112. As shown in FIG. 3, flap 122 is sewn to tubular body 102 in an area adjacent to edge 118 (FIG. 1). However, flap 122 may be attached to tubular body 102 by any suitable fastening mechanism, or flap 122 may integral to body 102.

Referring back to FIG. 1, a hook and loop strip 132(B) located on the inside surface of flap 112 facing tubular body 102, fastens to a corresponding hook/loop strip 132(A) located on second edge 120 of triangular opening 114, when flap 112 is wrapped around and adjustably covering expandable-vertical slit 112. As appreciated by those skilled in the art, after having the benefit of this disclosure, other fastening mechanisms may be used in lieu of Velcro strips, such as a zipper system, snaps, or other suitable connecting mechanisms.

Flap 122 may have dimensions that are larger than triangular opening 114 to ensure that opening 114 is fully enveloped when a fire-sprinkler-head assembly is contained within tubular body 102.

In one embodiment, collar 124 is a c-shaped with its opening (i.e., cut away) generally aligned with the opening of slit 112 i.e., the widest section of triangular opening 114. The remaining portion of collar 124 is coextensive with a boundary portion of open end 106 of body 102. Collar 124 is configured to expand to receive a fire-sprinkler-head assembly therein when body 102 is placed over the fire-sprinkler-head assembly.

In one embodiment, collar 124 includes a casing 126. A drawstring 128 is threaded through casing 126. A cordlock 130 may be used to pull drawstring 128 tightly around the portion of the fire-sprinkler-head assembly (typically a pipe), when device 100 is secured over the assembly.

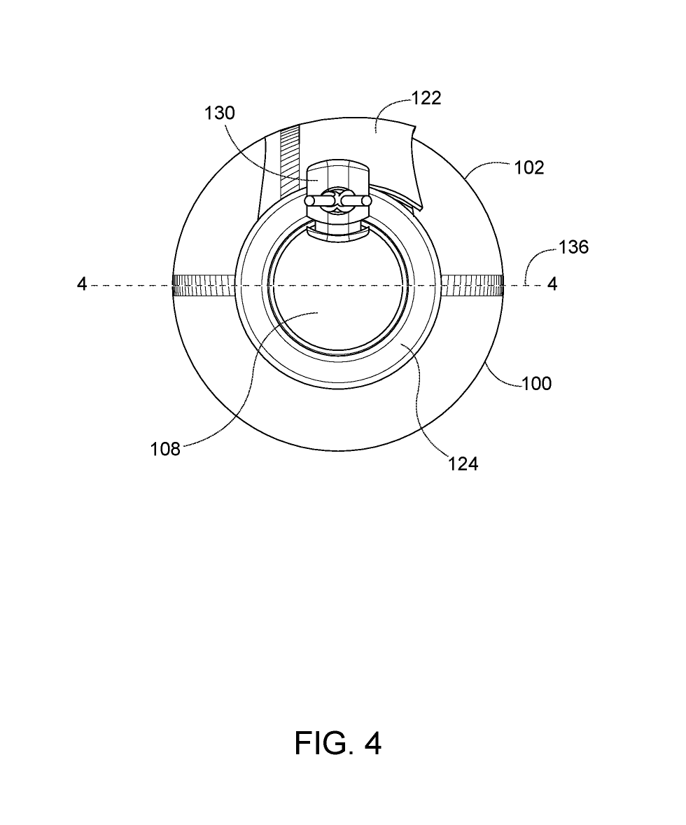

FIG. 4 shows a top view of collar 124 taken on line 4-4 of FIG. 1 looking into tubular body 102 from open end 106. As appreciated by those skilled in the art, after having the benefit of this disclosure, other fastening mechanism may be used in lieu of a drawstring, such as a belt, rope, or other suitable fastening mechanisms capable of securing (i.e., “closing”) open end 106 to/around a fixed object, such as a pipe.

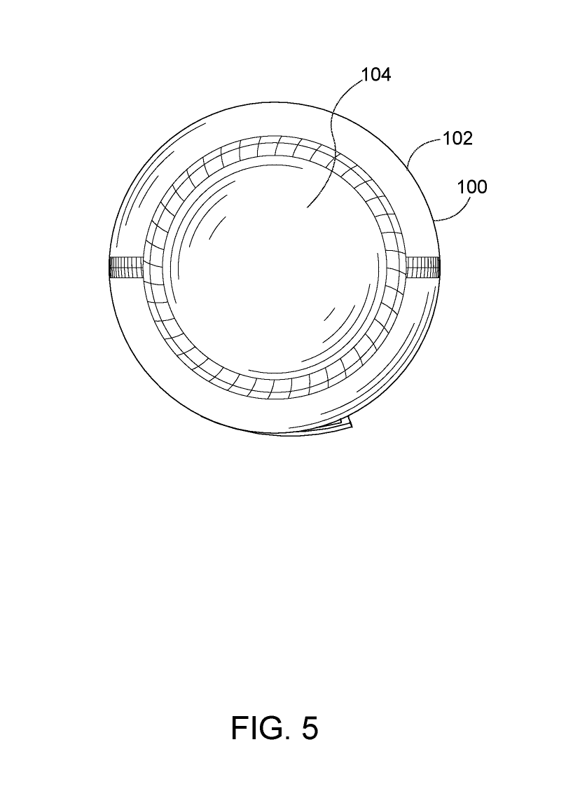

FIG. 5 shows a bottom view of tubular body 102 on line 5-5 of FIG. 1 viewed looking at the horizontal plane of the closed end 104 of example device 100. As depicted in the embodiment shown in FIG. 5, closed end 104 is circular, and has a diameter of about 2¾ inches. The diameter of closed end may be greater or smaller than about 2% inches.

FIG. 6 shows a transparent view of device 100 with a fire-sprinkler-head assembly 602 partially contained therein within bore 108.

In one embodiment, tubular body 102 may constructed as follows: Two sheets of flexible neoprene are cut to the shape and configuration mentioned above and sewn together thereby forming a tubular body composed of a flexible insulating material. In addition, a circular closed end piece of material is sewn at the aft end of the body 102, thereby to form closed end 104. This will create a bore 108 therethrough large enough to encase a fire-sprinkler-head assembly 602 therein. In addition, the tapering portions 110 are formed by cutting in the materials into the shape of bottle neck such that the tapering 110 in the tubular body 102 narrows toward the open end 106.

At least one sheet of the tubular body in the tapered portion is cutout in the shape of the expandable-vertical slit 112. In one embodiment, this expandable-vertical slit 112, disposed along the tapering portion 110, is in the form of a triangular opening 114 that extends along a portion of the tapering portion 110 in parallel with a vertical axis 134 of the tubular body 102, but may be other shapes or configurations. The expandable-vertical slit 112 widens toward the open end 106 of the tubular body 102, and narrows to a vertex 116 towards the closed end 104, wherein the expandable-vertical slit 112 includes a first edge 118, and a second edge 120 forming two sides of the triangular opening 114.

A flap 122 is fastened along the first edge 118 (and/or or the second edge 120) of the vertical slit 112. The flap 122 is secured to tubular body 102 in a manner to hingedly wrap around and adjustably cover the expandable-vertical slit 112. A collar 124 is formed at the distal end of the open end 106. The collar 124 is formed in a manner so it is coextensive with a boundary of a portion of the open end. The collar 124 is also configured in conjunction with open end 106 to expand to receive a fire-sprinkler-head assembly 602 therein when device 100 is placed over the fire-sprinkler-head assembly 602.

Glue may be applied to the seams forming tubular body 102. This will make device 100 generally waterproof, and will seal ice that melts into water from escaping the bore during a heat treatment. In embodiment, the glue is Aron Alpha Industrial Krazy Glue.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A device for protecting a fire-sprinkler-head assembly from excessive heat or cold, the device comprising:
a tubular body having a closed end and an open end, the tubular body composed of a flexible insulating material, and having a bore therethrough, the bore being generally cylindrical, and contoured to fit around and encase a fire-sprinkler-head assembly therein, the tubular body includes a tapering portion that narrows toward the open end;
an expandable-vertical slit, disposed along the tapering portion, the expandable-vertical slit having a triangular opening that extends along the tapering portion in parallel with a vertical axis of the tubular body, wherein the expandable-vertical slit widens toward the open end of the tubular body, and narrows to a vertex closest to the closed end, wherein the expandable-vertical slit includes a first edge, and a second edge forming two sides of the triangular opening;
a flap, composed of a flexible and stretchable insulating material, positioned along the first edge of the vertical slit, wherein the flap is configured to hingedly wrap around and adjustably cover the expandable-vertical slit;
a collar, coextensive with a boundary portion of the open end, is configured to expand to receive a fire-sprinkler-head assembly therein when the tubular body is placed over the fire-sprinkler-head assembly.

2. The device of claim 1, wherein the collar includes casing.

3. The device of claim 1, further comprising a drawstring threaded through a casing of the collar.

4. The device of claim 1, further comprising a drawstring threaded through a casing of the collar, and further comprising a cordlock fastened to the drawstring, wherein the drawstring is a bungee cord.

5. The device of claim 1, further comprising means for fastening the flap to tubular body.

6. The device of claim 1, further comprising loop and hook strips disposed on the second edge of the vertical slit, and on a portion of the flap corresponding to the second edge of the vertical slit when the flap is wrapped around and adjustably covering the expandable-vertical slit.

7. The device of claim 1, wherein the tubular body is about eight inches in length measured from the closed end to the open end of along a vertical axis of the tubular body.

8. The device of claim 1, wherein the closed end and open end of the tubular body are aligned along parallel horizontal axis, which are perpendicular to the vertical axis of the tubular body.

9. The device of claim 1, wherein the closed end includes a cylindrical cover having an external diameter of about 2¾ inches corresponding to external diameter of the tubular body measured at the closed end.

10. The device of claim 1, wherein the tapering portion of the tubular body begins tapering toward the open end about midway between the closed end and open end of the tubular body, measured along the vertical axis of the tubular body.

11. The device of claim 1, wherein the tapering portion of the tubular body begins tapering toward the open end about four inches away from the open end of the tubular body, measured along the vertical axis of the tubular body.

12. The device of claim 1, wherein the tubular body is about between 4 mm to 6 mm thick measured between an inner surface and exterior surface of the tubular body.

13. The device of claim 1, wherein the flap is about between 1 mm and 4 mm thick measure between an inner surface and exterior surface of the flap.

14. The device of claim 1, wherein the vertex of the triangular opening has an angle of about between 20 degrees and 50 degrees when the slit is in a non-expanded position.

15. A cover for a fire-sprinkler-head assembly, comprising:
a tubular body having a closed end and an open end, the tubular body composed of a flexible insulating material, and having a bore therethrough large enough to encase a fire-sprinkler-head assembly therein, the tubular body includes a tapering portion that narrows toward the open end;
an expandable-vertical slit, disposed along the tapering portion, the expandable-vertical slit having an opening that extends along a portion of the tapering portion in parallel with a vertical axis of the tubular body, wherein the expandable-vertical slit includes a first edge, and a second edge forming two sides of the opening;
a flap, positioned along the first edge of the vertical slit, wherein the flap is configured to hingedly wrap around and adjustably cover the expandable-vertical slit; and
a collar, coextensive with a boundary of the exterior portion of the open end, is configured to expand to receive a fire-sprinkler-head assembly therein when the cover is placed over the fire-sprinkler-head assembly.

16. The cover of claim 15, further comprising a drawstring threaded around the collar.

17. The cover of claim 15, further comprising means for fastening the flap to tubular body.

18. A method of making a cover for a fire-sprinkler-head assembly, the method comprising:
forming a tubular body composed of a flexible insulating material, a closed end and an open end, and a bore therethrough large enough to encase a fire-sprinkler-head assembly therein,
forming tapering portion in the tubular body that narrows toward the open end;
configuring an expandable-vertical slit, disposed along the tapering portion, the expandable-vertical slit having a triangular opening that extends along a portion of the tapering portion in parallel with a vertical axis of the tubular body, wherein the expandable-vertical slit widens toward the open end of the tubular body, and narrows to a vertex towards the closed end, wherein the expandable-vertical slit includes a first edge, and a second edge forming two sides of the triangular opening;
positioning a flap along the first edge of the vertical slit, configuring the flap to hingedly wrap around and adjustably cover the expandable-vertical slit;
forming a collar which is coextensive with a boundary of a portion of the open end; and
configuring the collar to expand to receive a fire-sprinkler-head assembly therein when the cover is placed over the fire-sprinkler-head assembly.
